(19) United States
(12) Patent Application Publication
(10) Pub. No.: US 2025/0342990 A1
(43) Pub. Date: Nov. 6, 2025

(54) METHOD FOR PRODUCING A MULTILAYER VARISTOR, USE OF METAL PASTE FOR FORMING METAL LAYERS, GREEN BODY FOR PRODUCING A MULTILAYER VARISTOR, AND MULTILAYER VARISTOR

(71) Applicant: TDK Electronics AG, München (DE)

(72) Inventors: Hermann GRÜNBICHLER, St. Josef in der Weststeiermark (AT); Stefan OBERMAIR, Stainz (AT); Roland HOHL, Krottendorf-Gaisfeld (AT)

(21) Appl. No.: 18/869,932

(22) PCT Filed: May 25, 2023
(86) PCT No.: PCT/EP2023/064062

§ 371 Date: Nov. 27, 2024

(30) Foreign Application Priority Data
Jun. 9, 2022 (DE) 102022114552.2

(51) Int. Cl. H01C 7/108; H01C 1/14

(52) U.S. Cl. CPC H01C 7/108; H01C 1/14

(57) ABSTRACT

Summary

The present invention relates to a method of manufacturing a multilayer varistor (1) comprising the steps of:
Preparing a metal paste (103) comprising silver and nickel, wherein the mass fraction of nickel in the metals of the metal paste (103) is at most 25%,
Applying of the metal paste (103) to a ceramic green film (102),
Applying of a further ceramic green film (102) to the metal paste (103) to produce a sandwich-like structure and Sintering of the green films (102) with the applied metal paste (103), whereby the green films (102) are converted into ceramic layers (2) and the metal paste (103) is converted into an inner electrode (3).

The present invention relates to a method of manufacturing a multilayer varistor, a green body for manufacturing a multilayer varistor, the use of a suitable metal paste and a multilayer varistor.

Zinc oxide-based ceramics with inner electrodes are typically used in multilayer varistor elements. The inner electrodes preferably comprise silver-palladium alloys, as these have a sufficiently high melting point to set the desired electronic properties in the varistor ceramic via sintering. Examples of such varistors and electrode compositions are disclosed, for example, in the patent applications EP 3 300 087 A1, CN 106782956 A or in the German publication DE 11 2019 003 625 T5.

In order to dispense with more expensive precious metals such as palladium, inner electrodes in current multilayer varistors are sometimes manufactured using the comparatively cheaper precious metal silver. In addition to zinc oxide, a high proportion of bismuth(III) oxide, for example, is added to the varistor ceramic in order to enable the required compaction and grain growth of the ceramic even at low sintering temperatures below the melting point of silver [see the German patent application DE 10 2015 120 640 A1 and the non-patent literature Bernik et al.: Ceramics-Silikáty 62(1), 8-14 (2018)].

During sintering, however, the silver electrode is then attacked by the molten bismuth(III) oxide and the silver is partially oxidized to Ag₂(I)BiO₃ or Ag(II)BiO₃. The higher the sintering temperature, the stronger the oxidation attack on the silver electrode. Bi₂O₃ melts between 817° C. and 824° C. [see the non-patent literature Sadecka et al.: Journal of Materials Science, 2017, 52(10), pp. 5503-5510].

The oxidation of the silver leads to the thinning or disappearance of the electrode.

In alternative approaches, attempts are being made to completely replace the precious metals in the varistor electrodes. The Chinese patent application CN 104658727 A, for example, discloses electrodes made of pure nickel. However, sintering is then only possible in a protective atmosphere with the exclusion of oxygen, whereby no varistor-active ceramic is produced. For this reason, this technology is not used commercially.

One aim of the present application is therefore to provide an alternative process for producing improved multilayer varistors.

The present invention relates to a method of manufacturing a multilayer varistor. The method comprises at least the steps described below, which are preferably carried out in the given order.

In one step, a metal paste comprising silver and nickel is prepared. The percentage by mass of nickel in the metals of the metal paste is more than 0% and at most 25% and preferably at least 0.15% and at most 20%. The percentages here and in the following are always based on mass fractions.

In particular, a silver phase and a nickel phase can be mixed to prepare the metal paste. The silver phase contains or consists of silver (Ag) and the nickel phase contains or consists of nickel(Ni). Silver and nickel are present, for example, in solid form as a powder or granulate or in liquid form as a melt or vapor. The process for mixing silver and nickel should not be particularly limited. In addition to silver and nickel, the paste can comprise other metals as well as organic and inorganic additives or auxiliary materials. Mixing achieves an even distribution of the nickel in the silver. The nickel is present in the form of fine particles.

Mixing the silver and nickel phases produces a single-phase or at least two-phase metal paste. Nickel can be dissolved in the metal phase up to a mass fraction of 0.15%, so that an Ag—Ni alloy is formed. Any additional nickel added is present in a separate nickel phase.

The proportion of nickel metal in the metals in the metal paste is therefore preferably at least 0.50%, more preferably at least 1.0% or 3.0%. The proportion of nickel is preferably so high that a nickel phase, which predominantly contains nickel, forms in the metal paste in addition to the silver phase.

A nickel metal content of more than 20% can damage the varistor. The maximum proportion of nickel in a metal paste is therefore preferably less than 20%, more preferably less than 19% or less than 17.5%.

In a further step, the metal paste is applied to a ceramic green film. The ceramic green film can contain any ceramic material in a non-sintered state. The ceramic material includes in particular various metal oxides, which form the starting materials of the ceramic, as well as organic binders and auxiliary materials and possibly additional dopants.

The metal paste can be screen printed onto the green films, for example. By adding organic solvents and additives, a target viscosity is then set in the metal paste that is suitable for screen printing.

In a further step, another ceramic green film is applied to the metal paste to produce a sandwich-like structure. In particular, the green film or another green film can also be applied next to the metal paste, for example to compensate for shrinkage during sintering. However, at least one side of the metal paste is exposed to the surroundings.

Furthermore, steps such as decarburization and debinding can take place before a sintering step.

In a further step, the green films are sintered with the applied metal paste in a joint process step, whereby the green films are converted into ceramic layers and the metal paste is converted into an inner electrode.

During sintering, nickel is preferentially diffused into transition layers of the forming ceramic layers and oxidized there. The transition layers are adjacent to the forming inner electrode. In this way, transition layers are formed adjacent to the inner electrode, in which a nickel oxide phase is formed. The Ni is oxidized to nickel(II) oxide (NiO), for example.

The nickel oxide phase can, for example, take the form of several cristallites or a continuous crystalline film.

In a preferred embodiment, the thickness of the transition layer is no more than 5 μm, more preferably no more than 3 μm.

Optionally, a stack of several green films can be formed, with metal paste applied to each or to selected green films, and the entire stack can be sintered together in a single process step. Before sintering, the green films are then preferably pressed together in order to bond the green films. Individual components of defined dimensions can then be cut from the stack before sintering, which is referred to as “cutting”. In the following, the term stack can therefore refer to both an uncut stack and a component cut out of a larger stack.

Steps such as decarburization and debinding can also take place before sintering.

Sintering takes place in an atmosphere with a significant oxygen content, for example in ambient air or in an oxygen-enriched atmosphere, in order to achieve sufficient grain growth and the desired grain boundary structure in the ceramic.

Each of the layers containing a metal paste may additionally comprise a ceramic green film or a section of green film.

Outer layers of the stack in one stacking direction are preferably each formed by a ceramic green film.

The metal paste is preferably exposed to the environment on at least one side of the stack or component. The metal paste thus forms a section of an outer surface of the stack on at least one side. Additional metal layers may be applied to the outer surface of the stack, in particular after sintering, and may be in contact with the metal paste inside the stack.

The outer metal layers may differ in composition from the composition of the metal paste.

The metal paste can have a different composition in each layer. Preferably, the metal paste always has the same composition in each layer.

The process described provides a multilayer varistor with electrodes containing silver, whereby the addition of other precious metals such as palladium can be dispensed with and the varistor can thus be produced more cost-effectively.

Furthermore, the nickel in the metal paste protects the silver from oxidative attacks during sintering of the ceramic, so that shrinkage of the electrode due to chemical reaction of the silver with the ceramic can be reduced and the use of silver material can be optimized.

In one embodiment, sintering is carried out at a temperature above 900° C., preferably above 940° C. or more preferably above 950° C. The maximum possible implementation temperature is below the melting temperature of the silver. The melting temperature of the silver under normal conditions is 962° C. If the silver melts because it is heated above its melting temperature, individual silver droplets form and the structure of the electrode is adversely affected.

Due to the protective effect of the nickel, the ceramic and the metal paste can be heated to below the melting point of silver and sintered in an oxygen atmosphere, making it possible to form a varistor ceramic with the required grain sizes and a corresponding grain boundary structure. The grain boundaries form the main electrical resistances in the ceramic material. In particular, larger grains with clearly defined grain boundaries can be produced.

The varistor properties can thus be improved by increasing the peak temperature during sintering. In particular, the electrical properties of the varistor can be improved. For example, by increasing the temperature during sintering, a varistor with a lower varistor voltage is obtained. The varistor voltage is defined as the voltage that must be applied to a varistor in order to generate an electric current of one milliampere (1 mA).

In one embodiment, silver makes up the largest proportion by mass of all components in the metal paste. In particular, silver makes up the largest mass fraction of all metals in the metal paste.

In one embodiment, the metal paste in the form of metals comprises only the metals silver and nickel.

The mass fraction of nickel in the metals of the metal paste is preferably at least 0.15% and at most 20%.

Preferably, the metal content of the metal paste consists of 0.15% to 20% nickel and 80% to 99.85% silver.

In one embodiment, the metal paste consists of silver, nickel and other non-metallic inorganic and organic components. The use of other precious metals in addition to silver can be dispensed with. The other components are, for example, organic binders or fillers, e.g. for shrinkage adjustment or to increase adhesion.

In one embodiment, the ceramic green films comprise ZnO and bismuth(III) oxide (Bi₂O₃). These can be used to form ceramics that have advantageous electrical properties for use in a varistor, such as a high threshold resistance or a low varistor voltage.

In one embodiment, the ceramic green films consist of at least 90% by mass of Zno and Bi₂O₃ or of Zno, Bi₂O₃ and antimony(III) oxide (Sb₂O₃). In this way, ceramics with desirable ceramic properties can be formed. Preferably, the ratio of bismuth Bi to antimony Sb in the ceramic is larger than 1:1 in order to suitably adjust the grain growth and grain structure.

The ceramic green film can also contain organic or inorganic binders, solvents, plasticizers, and other additives, for example.

In one embodiment, during sintering, nickel diffuses to the boundary between the inner electrode and the ceramic layers or into the layers of the forming ceramic layers adjacent to the forming inner electrode. These layers adjacent to the inner electrode are defined as the protection layer. After sintering, the ceramic in the protection layer is doped with nickel. Furthermore, a separate nickel phase can form in the protection layer.

One advantage of the present process is therefore the doping of the ceramic with nickel during sintering.

In the protection layer, at least a portion of the Ni is preferably oxidized to nickel(II) oxide (NiO), for example, and preferably forms the nickel oxide phase in the transition layer.

The Bi₂O₃ in the forming protection layer is preferably partially reduced to bismuth(II) oxide (Bio). The nickel oxide can then form nickel-zinc spinels, for example. With increasing proximity to the forming inner electrode, a higher proportion of Bi₂O₃ is therefore preferably reduced.

The nickel oxide phase in the transition layer then forms a barrier adjacent to the inner electrode, through which no further Bi₂O₃ can diffuse to the inner electrode and thus oxidation of the silver can be avoided.

The nickel in the inner electrode therefore has a multiple protective effect. On the one hand, the nickel is preferentially oxidized before the silver, as it is less noble and thus a protection layer is built up around the inner electrode by the diffusion of the Ni into the ceramic during sintering in which Bi₂O₃ is reduced. Furthermore, a barrier of nickel oxide is formed around the inner electrode in a transition layer adjacent to the inner electrode due to the oxidation of the nickel.

The process steps described can be followed by further optional process steps in further embodiments.

One example of such a process step is the pressing of the stacked layers in order to bond the layers together in a stable manner. Pressing is carried out before sintering.

After pressing, the stack can be cut into several components with defined dimensions in a further step (also known as cutting).

In a subsequent optional step, the organics, such as binding agents and additives, in the green films or the metal paste can be burned out by heating.

After these steps, the described sintering takes place.

Following sintering, external contacts can be applied to the multilayer varistor to electrically connect the formed inner electrodes. The outer contacts can be achieved, for example, by dipping the exit surfaces of the inner electrodes in a metal paste and then baking the paste.

The invention further relates to a multilayer varistor which is designed such that it can be manufactured by means of the method described above. However, the varistor is not intended to be limited to manufacture by the aforementioned method.

The invention further relates to a green body for producing a multilayer varistor. The green body may have all the features previously described in relation to the method and vice versa.

In particular, the green body comprises at least two ceramic green films and a metal layer arranged in a sandwich structure between the at least two ceramic green films.

The metal layer may comprise a metal paste comprising silver and nickel, wherein the mass fraction of nickel in the metals of the metal paste is at most 25%, and preferably at least 0.15% and at most 20%.

In addition to the metal paste, a ceramic green film can also be provided in the metal layer, which surrounds the metal paste on several sides. In at least one direction, the metal paste is exposed to the surroundings.

In a preferred embodiment, the metal paste consists exclusively of the metals silver and nickel and of non-metallic organic and/or inorganic components. The metal paste thus comprises exclusively the metals silver and nickel in the form of metals.

In a preferred embodiment, the ceramic green films consist of at least 90% by mass of Zno and Bi₂O₃ or of Zno, Bi₂O₃ and Sb₂O₃.

The present invention further relates to the use of a metal paste comprising silver and nickel for forming metal layers comprising silver in or on a Bi₂O₃-containing ceramic, wherein the mass fraction of nickel in the metals of the metal paste is at most 25% and preferably at least 0.15% and at most 20%.

The metal paste and the ceramic can have all the features described above and vice versa.

In particular, ceramics containing lead can be replaced by ceramics containing bismuth oxide and contacted with silver electrodes, as the bismuth oxide does not or hardly attacks the silver in the forming metal layer during sintering due to the nickel content in the metal paste.

In embodiments, the metal paste may comprise the metals silver, nickel and other non-metallic organic and/or inorganic components.

The metal layer formed preferably comprises only silver as the metal, as the nickel diffuses into the ceramic during the manufacturing process.

The ceramic can consist of at least 90% by mass of ZnO and Bi₂O₃ or of Zno, Bi₂O₃ and Sb₂O₃.

The present invention further relates to a multilayer varistor. The varistor can be designed analogously to the previously mentioned embodiments. The ceramic layers, inner electrodes and other elements of the varistor may have the same features as described above.

The varistor can preferably be manufactured using the process described above.

The varistor comprises at least two ceramic layers and an inner electrode, which is arranged in a sandwich structure between the two ceramic layers and comprises silver.

Adjacent to the inner electrode, a transition layer is formed in each of the ceramic layers, in which a nickel oxide phase is formed. The nickel oxide phase is preferably formed between the inner electrode and the other ceramic layers.

Preferably, the nickel oxide phase is formed as a continuous film. Particularly preferably, the nickel oxide phase is formed as a continuous film which separates the inner electrode from the rest of the ceramic and thus forms a continuous barrier between the inner electrode and the rest of the ceramic.

In an alternative embodiment, the nickel oxide phase is in the form of several discontiguous cristallites.

Furthermore, a nickel oxide phase can also be formed outside the transition layer or inside the inner electrode.

The transition layer preferably has a maximum thickness of 5 μm.

In one embodiment, a protection layer is formed in each of the ceramic layers adjacent to the inner electrode, in which bismuth oxides are predominantly present in the reduced form BiO.

Preferably, the bismuth oxides are increasingly present in the reduced form Bio with increasing proximity to the inner electrode.

Preferably, the protection layer also has an increased doping with nickel compared to the rest of the ceramic. The protection layer is adjacent to the inner electrode and comprises the transition layer defined above.

The thickness of the transition layer is 40 μm, for example. In particular, the thickness of the transition layer is preferably no more than ten times the thickness of the inner electrode.

In one embodiment, the ceramic layers outside the protection layers consist of at least 90% by mass of zinc oxide and bismuth oxides or of zinc oxide, bismuth oxides and antimony oxides. The zinc oxides include in particular Zno, the bismuth oxides include in particular Bio and Bi₂O₃, the antimony oxides include in particular Sb₂O₃.

Furthermore, the ceramic layers also contain NiO, which is formed at least in a transition layer adjacent to the inner electrode during sintering due to the oxidation of the nickel from the metal paste.

In one embodiment, the mass fraction of elemental (elementary) nickel in relation to the sum of the total masses of elemental nickel and silver in the multilayer varistor is a maximum of 25%.

In the following, embodiments of the invention are explained in more detail with reference to figures. The invention is not limited to the following embodiments.

The figures show:

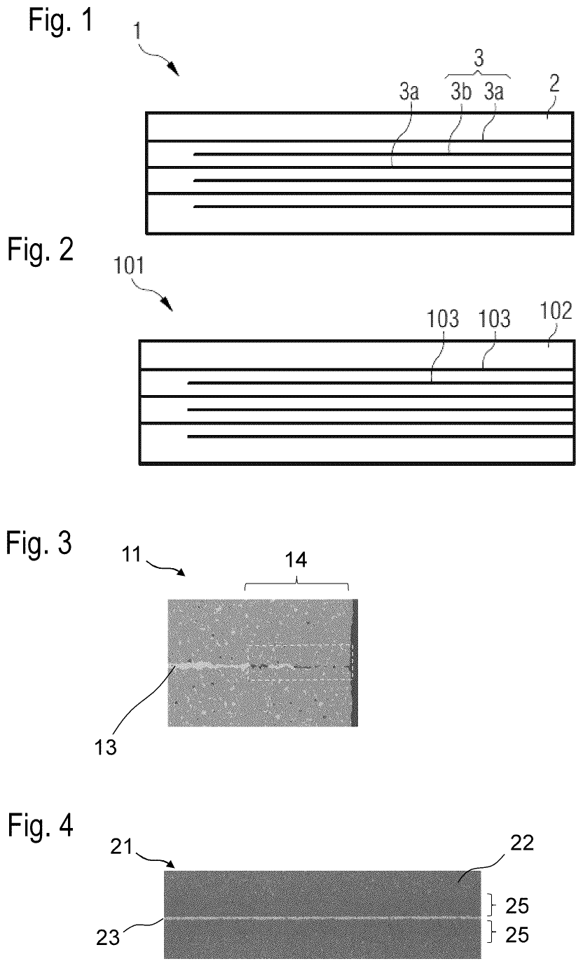

FIG. 1: Design example of a multilayer varistor in cross-section.

FIG. 2: Cross-section of multilayer varistor before sintering.

FIG. 3: SEM microscope image of the silver electrode of a varistor not according to the invention.

FIG. 4: Light microscope image of the inner electrode of a varistor according to the invention.

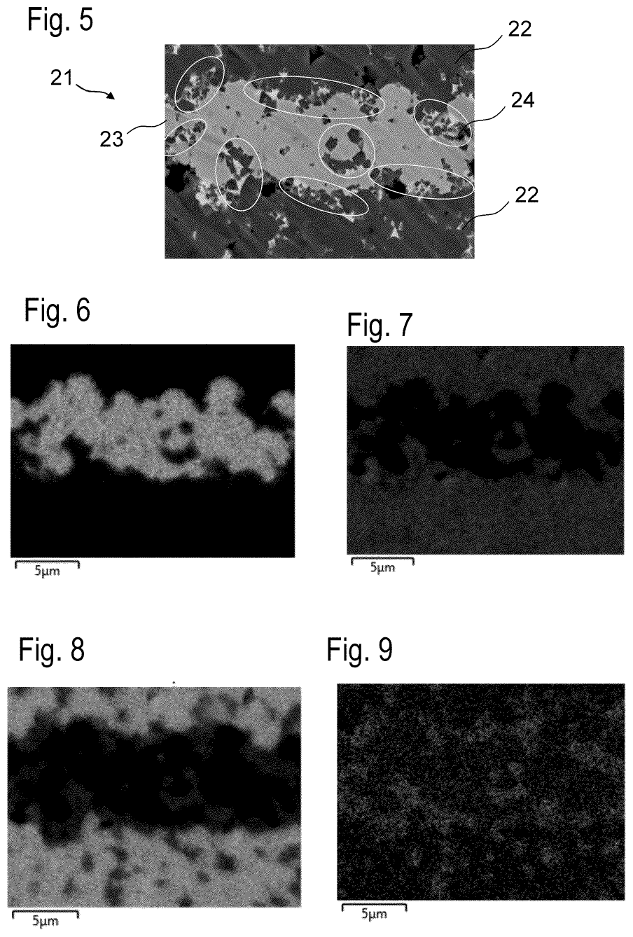

FIG. 5: Enlarged SEM microscope image of the inner electrode of a varistor according to the invention.

FIG. 6: EDX concentration distribution of the element silver in the section from FIG. 5.

FIG. 7: EDX concentration distribution of the element oxygen in the section from FIG. 5.

FIG. 8: EDX concentration distribution of the element zinc in the section from FIG. 5.

FIG. 9: EDX concentration distribution of the element nickel in the section from FIG. 5.

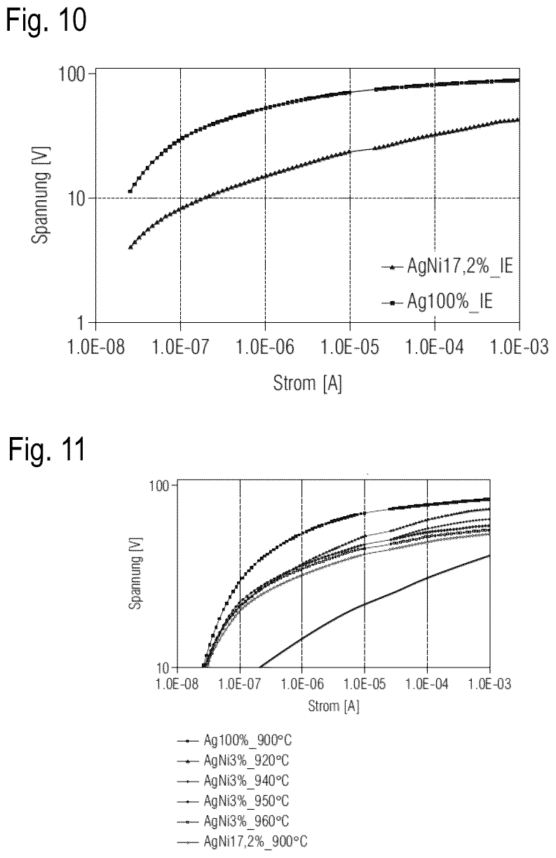

FIG. 10: Characteristic varistor curves of a silver electrode and an Ag—Ni electrode.

FIG. 11: Characteristic varistor curves of a silver electrode and various Ag—Ni electrodes.

FIG. 1 shows a first example of the varistor 1 according to the invention. It is a multilayer varistor in which ceramic layers 2 and intermediate layers with inner electrodes 3 are alternately stacked. The inner electrodes 3 are surrounded by ceramic and are each exposed on one side of the outer surface of the varistor 1.

In the present embodiment example, each second inner electrode 3a is exposed in the stacking direction on a first side and the respective inner electrode 3b lying between them in the stacking direction is exposed on a second side, which is opposite the first side.

The inner electrodes are preferably made exclusively of silver.

The ceramic is a zinc-bismuth ceramic that contains ZnO and Bi₂O₃. The ceramic may also contain other metal oxides, in particular zinc oxides, bismuth oxides and antimony oxides, as well as dopants.

Ceramic green films containing the aforementioned metal oxides in a predetermined composition are provided to manufacture the varistor 1. The green films are printed with a metal paste using screen printing, for example. The metal paste contains silver and nickel. The proportion of nickel in the metals of the metal paste is between 0.15% and 20% in the example. By adding organic solvents and additives, a target viscosity of the metal paste is set that is suitable for screen printing.

In a subsequent step, printed and unprinted green films are then stacked on top of each other in a defined sequence and with high positional accuracy in order to realize the described layered structure of the varistor.

The stack is then mechanically pressed to bond the layers together in a stable manner. Components with defined sizes are then produced from the stack by cutting at predetermined positions. An exemplary varistor component 101 in the green state is shown in FIG. 2. The varistor component 101 comprises a stack of green ceramic layers 102 and layers of metal paste 103.

In a subsequent step, the organic binders and additives present in the ceramic green films and in the metal paste are burnt out to ensure the necessary strength in the aforementioned process steps. For this purpose, the components are heated in an oven for a sufficiently long time.

After burning out the organic components, the components are sintered. Due to the protective effect of the nickel content in the metal paste, the sintering temperature at the peak can be heated to just below the melting temperature of the silver. The sintering temperature is maintained for a sufficiently long time, for example over 180 minutes.

The sintered varistor components are then electrically contacted. External electrodes are applied in order to be able to contact the components electrically. These are achieved, for example, by immersing the exit surfaces of the inner electrodes in a silver paste and then baking the silver paste. Baking takes place at a temperature of approx. 650 to 700° C., for example.

FIG. 3 shows a varistor 11 not according to the invention with an ordinary silver electrode 13, without nickel additive. Due to the high prices of other precious metals such as palladium, silver is preferably used for the inner electrodes in varistors.

On the other hand, sufficiently high sintering temperatures are required to form suitable electrical properties of the varistor in order to suitably adjust grain growth and grain boundary structures. However, silver has a comparatively low sintering temperature compared to other precious metals.

The desired electrical properties are then discussed with reference to FIGS. 10 and 11.

Zinc oxide ceramics, which have good varistor properties, are usually used in multilayer varistors.

When using pure silver electrodes, as in the non-inventive example in FIG. 3, a zinc-oxide ceramic of conventional composition is not suitable as a varistor ceramic. Below the melting point of Ag, the suitable structure could not be produced with such a zinc-oxide ceramic. Therefore, an increased proportion of bismuth oxide, for example, is added to the ceramic composition in order to enable the formation of grain boundary structures and grain growth to the desired extent even at temperatures below the melting temperature of Ag.

However, the disadvantage of adding a lot of bismuth(III) oxide Bi₂O₃ is its reactivity, which leads to oxidation of part of the silver material during sintering. Particularly in an outer areas 14 of the inner electrodes 13, which are close to the outer surfaces of the varistor 11 and are therefore in contact with oxygen from the sintering atmosphere, the Ag is completely oxidized, which impairs the electrical contacting of the electrodes.

FIG. 3 shows an SEM microscope image (micrograph) of a section through a multilayer varistor 11. The inner electrode 13 made of pure silver is heavily diluted in the outer area 14 due to oxidative attack.

The silver diffused into the ceramic further deteriorates the insulating properties of the ceramic.

FIG. 4 shows how the nickel additive has a protective effect on the inner electrode 23, which is preferably made of Ag.

Nickel is a less noble metal than silver. Therefore, nickel is preferentially oxidized by Bi₂O₃. The silver thus remains in its reduced metallic form.

Furthermore, due to the diffusion of the nickel into the ceramic, the partial oxidation of the nickel and the partial reduction of the bismuth oxide, a layer comprising nickel oxide NiO and bismuth(II) oxide Bio is formed, particularly in the areas of the ceramic layers 22 adjacent to the inner electrode.

In the SEM microscope image through a corresponding varistor 21 according to the invention in FIG. 4, the protection layer 25 formed in this way can be seen. The NiO can, for example, react further with ZnO to form Ni—Zn spinels, which further impede the access of the Bi₂O₃ to the inner electrode.

In FIG. 4, the bright spots in the ceramic show the Bi₂O₃ phase. Adjacent to the inner electrode 23, none of these bright spots can be seen in the protection layer 25, so that after a sufficient amount of nickel has been oxidized, Bi₂O₃ no longer reaches the electrode and therefore no further nickel or silver can be oxidized. Instead, dark spots can be seen in the protection layer, which indicate the formation of a BiO phase. The protection layer 25 is approximately ten times the thickness of the inner electrode 23, for example.

FIG. 5 shows an enlarged view of the SEM micrograph, in which the nickel oxide phases can be seen as fine-grained cristallites 24 of the inner electrode 23 in and adjacent to the inner electrode 23 in a transition layer. The cristallites 24 are marked in a circle and form a diffusion barrier between the ceramic and the inner electrode.

FIG. 6 shows the distribution of the concentration of the element silver in the varistor within the section shown in FIG. 5, determined by EDX, i.e. by energy dispersive X-ray spectroscopy.

FIG. 7 shows the distribution of the element oxygen in the same way. And FIG. 8 shows the distribution of the element zinc in the same way. A high concentration is shown in light, a low concentration in dark.

It can be seen that there is no oxygen in the silver layer and no silver in the oxygen-rich phase, so that the silver cannot be oxidized. The silver layer of the inner electrode is therefore protected from oxidative attack.

It can also be seen that the ceramic zinc oxide phase, i.e. the area in which zinc and oxygen are present, does not extend as far as the silver layer shown in FIG. 6.

FIG. 9 shows the EDX concentration distribution of the element nickel. FIG. 9 shows that a nickel-rich phase is formed between the zinc-rich and silver-rich areas. FIG. 7 shows that the nickel-rich phase is also rich in oxygen. These are the nickel oxide cristallites 24 shown in FIG. 5.

Since the electrodes are thus protected from oxidative attacks on the silver or nickel, the electrodes can be made thinner in the stacking direction, namely up to at least 6 μm, preferably 5 μm, even more preferably 4 μm. This saves metal and in particular silver material for the formation of the electrodes. This ensures electrical contact with the outside.

FIGS. 10 and 11 show electrical characteristics, namely current-voltage characteristics, of various varistor components.

In the double-logarithmic diagrams, the current in A is shown on the x-axis and the voltage in V on the y-axis.

In FIG. 10, the characteristic curve of a nickel-free varistor with a silver electrode is compared with the characteristic curve of the electrode of a varistor with a nickel content in the metal paste of 15% (or 17.2% by volume) in relation to the sum of the masses of silver and nickel in the metal paste of the green body. The characteristic curve of the nickel-free varistor is shown at the top and that of the Ag-nickel varistor at the bottom of the diagram. Both electrodes were sintered at 900° C.

In particular, the breakdown voltage, i.e. the voltage above which the varistor is electrically conductible, and the non-linearity of the curves, which is a benchmark of the quality of the varistor, are examined.

A higher non-linearity demonstrates a better switching behavior between electrically conductive and electrically non-conductive states. The curve below shows that a similar characteristic can be achieved by adding nickel, but without the problems previously discussed in relation to FIGS. 2 and 3 regarding material consumption and external contacting.

In addition to the characteristic curve of a nickel-free varistor with a silver electrode, i.e. the top curve in the diagram, and the characteristic curve of the previously described varistor with 15% nickel content, i.e. the bottom curve in the diagram, five further characteristic curves are shown in FIG. 11.

The five other characteristic curves were all measured with electrodes from varistors containing a nickel content of 2.6% (3% by volume) in the metal paste in relation to the total mass of Ni and Ag in the metal paste of the green body.

The various varistors, each with a nickel content of 2.6%, were all sintered at different temperatures. The top curve belongs to an electrode that was sintered at 900° C., the next to an electrode that was sintered at 920° C., the next to an electrode that was sintered at 940° C., the next to an electrode that was sintered at 950° C. and the bottom to an electrode that was sintered at 960° C. As described, the two other characteristic curves in FIG. 10 belong to electrodes that were sintered at 900° C. in each case.

FIG. 11 shows that lowering the nickel content leads to an approximation of the non-linearity of the curves to the curve of the pure silver electrode. In particular, the non-linearity of the curves can thus be further improved.

The varistor voltage, i.e. the voltage required to achieve a current flow of 1 mA, can be significantly reduced by increasing the sintering temperature. In the example, the varistor voltage of the silver electrode in the varistor without nickel is 82 volts, while the varistor voltage of the electrode in the Ag—Ni varistor with 2.6% Ni, sintered at 960° C., is 55 volts. This is a reduction in the varistor voltage of 33%.

This significantly extends the possibilities for setting the characteristic curves via the sintering temperature. Similarly high sintering temperatures are not possible when using pure silver electrodes, as this would lead to the destruction of the silver electrode.

### LIST OF REFERENCE SYMBOLS

1,11,21 sintered varistor
2,22 ceramic layers
3,13,23 inner electrodes
3a left-sided inner electrodes
3b right-sided inner electrodes
14 outer area
24 NiO cristallites
25 protection layers
101 varistor in green state
102 ceramic green layers
103 metal paste

1-31. (canceled)

32. A method of manufacturing a multilayer varistor comprising the steps of:
preparing a metal paste comprising silver and nickel, wherein a mass fraction of nickel in metals of the metal paste is at most 25%,
applying the metal paste to a ceramic green film;
applying a further ceramic green film to the metal paste to produce a sandwich-like structure; and
sintering the green films and the applied metal paste, whereby the green films are converted into ceramic layers and the metal paste is converted into an inner electrode.

33. The method according to claim 32, wherein during the sintering, nickel of the metal paste diffuses into layers of the ceramic layers adjacent to form transition layers adjacent to the inner electrode, the nickel being oxidized so that a nickel oxide phase is formed in the transition layers.

34. The method according to claim 32, wherein the sintering is carried out at a temperature above 900° C.

35. The method according to claim 34, wherein the sintering is carried out at a temperature above 940° C., or above 950° C.

36. The method according to claim 32, wherein the metals of the metal paste include exclusively silver and nickel.

37. The method according to claim 33, wherein the transition layers have a thickness of at most 5 μm.

38. The method according to claim 32, wherein the ceramic green films are formed at least 90% by mass of (i) ZnO and Bi₂O₃ or (ii) ZnO, Bi₂O₃ and Sb₂O₃.

39. The method according to claim 32, wherein during sintering, nickel of the metal paste diffuses into layers of the ceramic layers to form protection layers adjacent to the inner electrode.

40. The method according to claim 39, wherein Bi₂O₃ is partially reduced to BiO in the protection layers.

41. The method according to claim 40, wherein a higher proportion of the Bi₂O₃ in the protection layers is reduced with increasing proximity to the inner electrode.

42. The method according to claim 32, wherein the sintering takes place in an atmosphere that includes oxygen.

43. The method according to claim 42, wherein the sintering takes place in ambient air.

44. The method according to claim 32, wherein the mass fraction of nickel in the metals of the metal paste is at least 0.15% and at most 20%.

45. A green body for producing a multilayer varistor comprising:
two ceramic green films; and
a metal layer which is arranged in a sandwich structure between the two ceramic green films, the metal layer including a metal paste containing silver and nickel, wherein a mass fraction of nickel in metals of the metal paste is at most 25%.

46. The green body according to claim 45, wherein the metals of the metal paste include exclusively silver and nickel.

47. The green body according to claim 45, wherein the mass fraction of nickel in the metals of the metal paste is at least 0.15% and at most 20%.

48. The green body according to claim 45, wherein the ceramic green films are formed of at least 90% by mass of (i) ZnO and Bi₂O₃ or (ii) ZnO, Bi₂O₃ and Sb₂O₃.

49. A method comprising using a metal paste containing silver and nickel to form silver-containing metal layers in or on a Bi₂O₃-containing ceramic, a mass fraction of nickel in metals of the metal paste being at most 25%.

50. The method according to claim 49, wherein the metals of the metal paste include exclusively silver and nickel.

51. The method according to claim 49, wherein metals in the silver-containing metal layers formed using the metal paste include exclusively silver.

52. The method according to claim 49, wherein the ceramic includes at least 90% by mass of (i) ZnO and Bi₂O₃ or of (ii) ZnO, Bi₂O₃ and Sb₂O₃.

53. A multilayer varistor comprising:
at least two ceramic layers; and
an inner electrode which is arranged in a sandwich structure between the at least two ceramic layers and contains silver,
wherein a transition layer is formed in at least one of the ceramic layers that is adjacent to the inner electrode, a nickel oxide phase being formed in the transition layer.

54. The multilayer varistor according to claim 53, wherein the nickel oxide phase is formed between the inner electrode and at least one other ceramic layers.

55. The multilayer varistor according to claim 53, wherein the nickel oxide phase is formed in the form of a continuous film.

56. The multilayer varistor according to claim 53, wherein the nickel oxide phase is formed in the form of a plurality of non-contiguous crystallites.

57. The multilayer varistor according to claim 53, wherein the transition layer has a thickness of at most 5 μm.

58. The multilayer varistor according to claim 53, wherein the inner electrode contains exclusively silver as metal.

59. The multilayer varistor according to claim 53, wherein a protection layer is formed in each of the at least two ceramic layers that is adjacent to the inner electrode, the protection layers including bismuth oxides that are predominantly present as BiO.

60. The multilayer varistor according to claim 59, wherein the bismuth oxides are increasingly present as BiO in the protection layers with increasing proximity to the inner electrode.

61. The multilayer varistor according to claim 59, wherein ceramic layers of the at least two ceramic layers that are outside the protection layers have a mass fraction of at least 90% of (i) zinc oxide and bismuth oxides or (ii) zinc oxide, bismuth oxides and antimony oxides.

62. The multilayer varistor according to claim 53, wherein a mass fraction of elemental nickel in the multilayer varistor in relation to a sum of total masses of elemental nickel and silver in the multilayer varistor is at most 25%.
